(19) United States
(12) Patent Application Publication
(10) Pub. No.: US 2005/0035155 A1
(43) Pub. Date: Feb. 17, 2005

(54) Dispersion system for dispersing material especially wood chips wood-fibre or similar on a dispersing conveyor belt

(76) Inventors: Werner Gawlitta, Tegelen (NL); Klaus Gerhardt, Germany (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/499,480

(22) PCT Filed: Dec. 12, 2002
(86) PCT No.: PCT/EP02/14140

(30) Foreign Application Priority Data
Dec. 21, 2001 (DE) 101 63 054.9

(51) Int. Cl. G01F 13/00; G01F 11/00

(52) U.S. Cl. 222/217

(57) ABSTRACT

The invention relates to a dispersion system for dispersing material, especially wood chips, wood fibres or similar, on a dispersing conveyor belt (1) in such a manner that groups of material (M) are formed during the production of chipboard, fibre-board or similar wood material boards. Said system comprises a dispersion material bunker (2) with a dosing unit (3) made from at least one dosing strip (4) and optionally, one or more dosing and/or disintegrating cylinders (5) for dispersing the material on one dispersion head (7) arranged on the end of the dosing unit and above the dispersing conveyor belt. The dispersion head is embodied in the form of a perforated dispersion head with a perforated base (8) and a plurality of agitating elements (9) are disposed at a predetermined distance above said base (8) and form a predetermined agitating width (B).

### DESCRIPTION

The invention relates to an apparatus for spreading particles, in particular glue-coated wood chips, fibers or the like on a conveyor belt to form a particle mat used for making chipboard, fiberboard, or the like structural wood panels, having a particle supply with a feeding unit comprised of at least one feed belt and if necessary one or more feeding and/or separating rollers for spreading the particles to a distributing head mounted at an end of the feeding unit above the conveyor belt. The feeding/and or separating roller can move to separate the particles and/or break up clumps or wads of the particles. To this end for example several separating roller can be provided above the feed belt so that the feeding function can largely be taken care of by the feed belt. It is also however possible that the one or more rollers are provided at the end spaced along the conveying direction that are constituted mainly as feed rollers.

Such apparatuses for spreading, in particular, wood chips or fibers are known in many forms. In the known spreading apparatuses the distributing head is mainly formed as a roller-type distributing head with a plurality of distributing rollers that together form a distributing-roller array. The apparatuses known to date are good, but could be improved.

In addition an apparatus for spreading fibers on a belt or mesh is known having a housing with an opening in its floor across which a mesh is stretched on which the fibers are strewed. The fibers are supplied by a plurality of hood-shaped supply devices that are contained in a housing and provided with feed lines. In addition several rows of stirrers are provided in the housing that keep the fibers in motion. The individual rows of stirrers are separated from one another by partitions. These partitions extend perpendicular to the movement direction of the belt and are provided with openings through the fibers can move from one row to the next (see German 2,848,459).

It is an object of the invention to provide a spreading apparatus of the above-described type which is very compact and produces a uniform distribution of the fibers on the particle conveyor.

This object is attained in an apparatus for spreading particles wherein the distributing head is formed as a sifter with a foraminous floor and a plurality of stirring elements spaced above the foraminous floor and each having a predetermined stirring diameter. Here the distributing head preferably has a plurality of rows spaced apart in and extending transverse to a travel direction of the particle conveyor and each holding a plurality of the stirring elements. Furthermore, the stirring elements or their stirring surfaces lie in a plane. The particles pass over the feeding belt or the feeding rollers so that these particles are discharged into the upstream stirring-element row and from there partly fall through the foraminous floor onto the particle conveyor and partly are moved in the travel direction or band-advance direction inside the distributing head from one stirring-element row to the next or inside each row transversely to the belt-advance direction. In this manner even with a relatively flat structure of the distributing head the particles are distributed uniformly onto the particle conveyor without clumps forming in the particles. In addition the stirring elements reduce particle side or break up clumps. The travel direction corresponds to the travel direction of the particle conveyor, that is the belt-travel direction. This is generally the travel direction of the feeding belt.

According to a preferred embodiment the stirring elements each comprise a rotatable axle extending generally perpendicular to the foraminous floor and carrying a stirring blade of the predetermined stirring diameter. Thus the stirring elements according to the invention are of particularly simple construction and operation. The stirring blades rotate in a plane generally parallel to and immediately above the foraminous floor. Each stirring blade has two arms that define the stirring diameter. It is also possible for the stirring blade to have two or more arms to form a double blade. The two arms can for example be eccentric and connected to the axle at spacings from the axis.

Preferably the stirring elements of each row all rotate in the same direction. In contrast the stirring elements in each row rotate oppositely to the stirring elements in adjacent rows. The rotations speeds of the individual stirring elements are the same for the entire spreader head. Basically however there is the possibility to drive the rows each separately or the set different rotation speeds for the individual stirring elements in a single row. In this regard it is possible to provide a separate drive for each individual stirring element. It is however possible to provide a common drive and transmission for the stirring elements of one or more rows or even for the entire spreading head.

In a preferred further embodiment of the invention a spacing between adjacent stirring elements in each row generally corresponds to the stirring diameter of the stirring elements. This spacing is the distance between the axes of the stirring elements so that the stirring elements are closely juxtaposed. This insures that at most very small spaces in which the fibers cannot be reached by the stirring elements are left between the individual stirring elements. It is understood that the spacing between the stirring elements an only be set so small that the stirring elements do not hit each other. In order to distribute the particles as uniformly as possible, the stirring-element rows are staggered by a predetermined offset distance to one another crosswise to the travel direction. The offset distance of adjacent rows is generally equal to half the stirring diameter, giving a staggered layout. In this arrangement it is advantageous when a distance between adjacent rows is slightly less than the stirring diameter. With an appropriate staggering of adjacent rows transverse to the transport direction it is possible to set the spacing of adjacent rows to less than the stirring diameter without the circular stirring zones overlapping. The result is an extremely compact construction that nonetheless produces a very uniform particle distribution.

According to a further suggestion of the invention the stirring elements each have at last one fan blade spaced from the stirring blade. This predetermined spacing preferably above the stirring blade of the fan blade produces an air stream or blowing effect that further agitates the fibers around the stirring elements and drives them through the foraminous floor onto the particle conveyor. In this system a particularly good effect is achieved when the fan blade is angled seen from the side relative to the stirring blade. It is also possible to orient the fan blade generally parallel to the stirring blade. Furthermore the spacing between the fan blade and stirring blade can be adjustable. This is done by making the fan blade adjustable, e.g. slidable, on the axle of the stirring element. By setting a preferred spacing between the fan blade and the stirring blade the air stream coming from the fan or its blowing effect can be specially controlled and directed.

According to a further suggestion of the invention one or more suction boxes are provided on a side of the foraminous floor opposite the particle conveyor, that is underneath it. These accelerate the fibers as they move toward the particle conveyor so that the movement of the particles through the foraminous floor is increased. To this end the particle conveyor is a mesh belt that allows air to pass through it. In addition it is suggested that the distributing head is provided at its downstream end with an outfeed device extending perpendicular to the travel direction or the belt-advance direction for coarse particles and/or excess material. This outfeed device can be an outfeed auger or aspirating tube or the like. In any case this ensures that coarse particles or excess material that is moved bye the stirring elements all the way to the downstream end of the distributing head are carried off or even fed back to the distributing head. In addition the distributing head is constructed such that the spreading width of the distributing head is slightly larger than a width of the panels being produced. This prevents that irregularities or thickness variations of the particle mate are produces in the edges that would have an effect on the plate quality.

According to a further suggestion of the invention partitions are provided between adjacent stirring elements of a row that form feed passages extending generally in the travel direction or belt-advance direction. The partitions and/or the feed passages are sinusoidal seen from above. This is the case when as described above the individual rows are staggered transversely to the transport direction. The partitions extending generally in the transport direction ensure a particularly uniform distribution of the particles. Similarly the sinusoidal shape ensures a uniform distribution over the entire belt width. Finally it is possible for the partitions to have filler segments at stirring-zone corners that generally fully cover or fill up the stirring-zone corners. This prevents too many particles from getting through the foraminous floor and onto the particle conveyors at the corners. As a result the particles are extremely evenly spread over the particle conveyor. Local overloads are avoided.

The invention is more closely described in the follow with references to drawing showing a single embodiment. Therein:

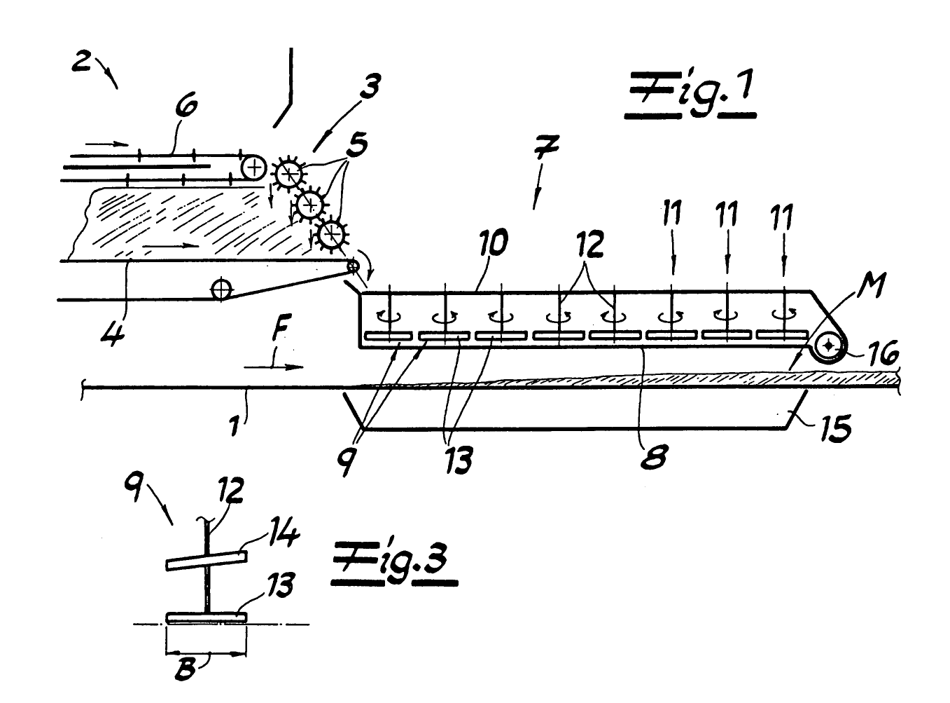

FIG. 1 is a schematic side view of a spreading apparatus according to the invention;

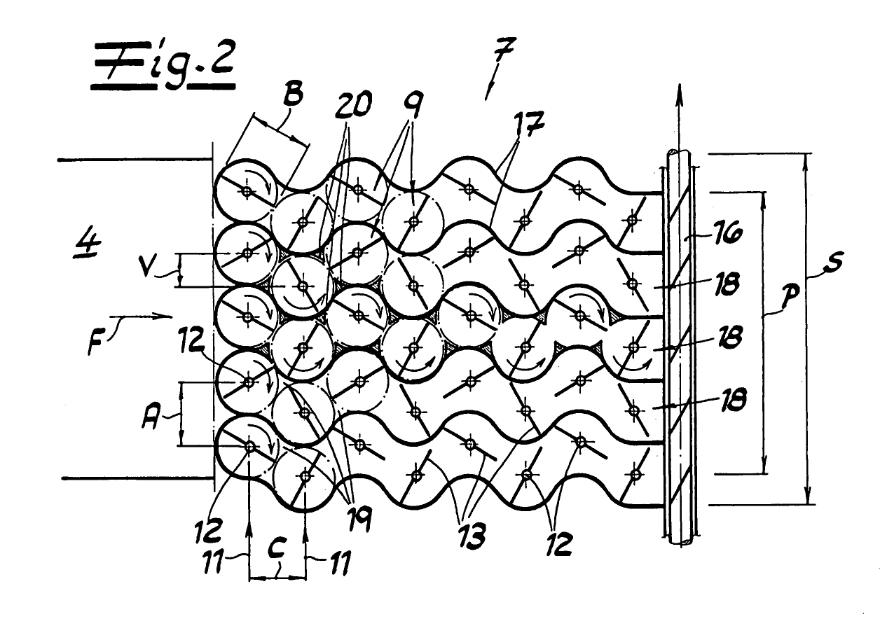

FIG. 2 is a detail of a top view of the apparatus of FIG. 1;

FIG. 3 is an alternative form of a stirring element;

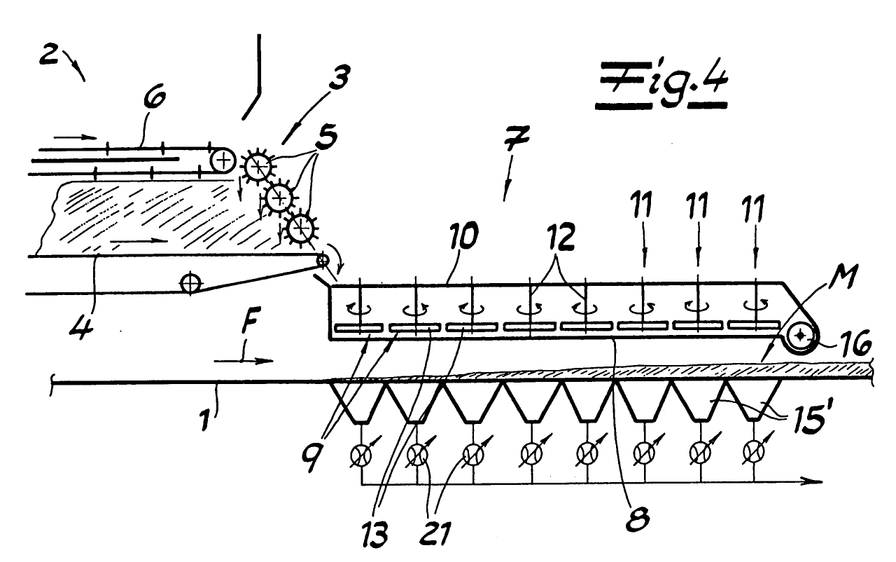

FIG. 4 is a variation on the system according to FIG. 1;

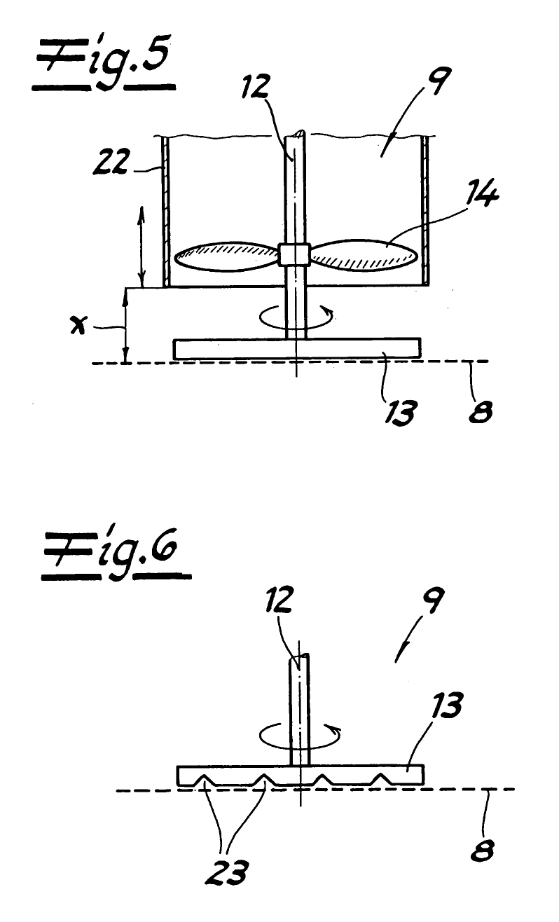

FIG. 5 is a variation on the system according to FIG. 3;

FIG. 6 is a detail view of another embodiment of the stirring element;

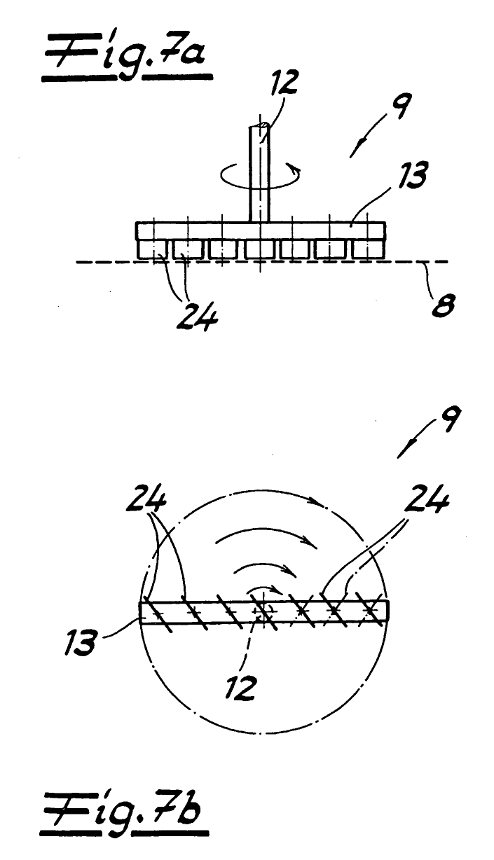

FIG. 7a is a variation on the system of FIG. 6;

FIG. 7b is a bottom view of the system of FIG. 7a;

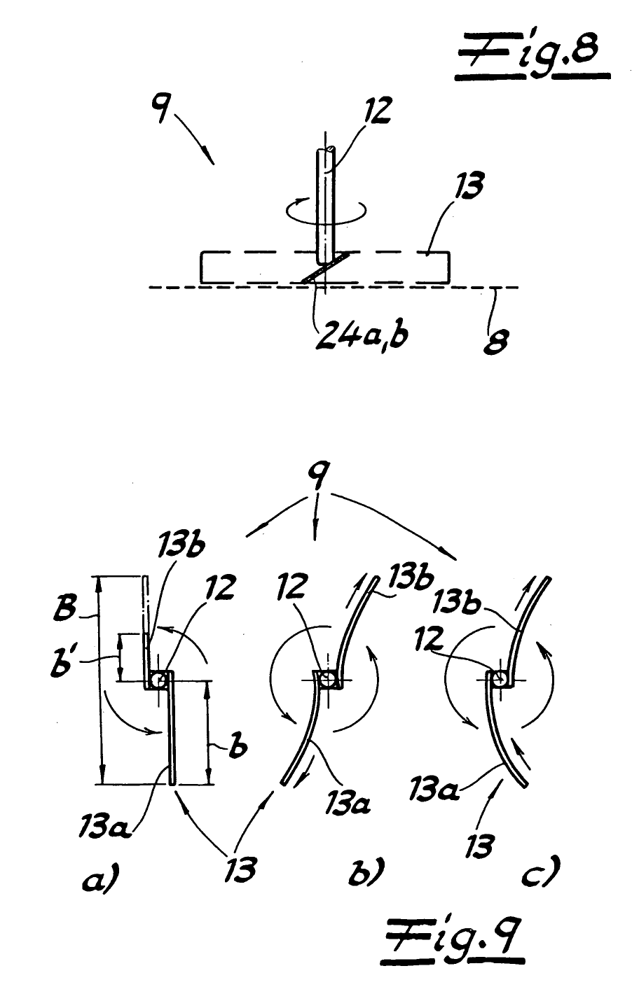

FIG. 8 is another embodiment of the system of FIG. 6;

FIG. 9a is a bottom view of another embodiment of a stirring element according to the invention;

FIG. 9b is a variation on the system of FIG. 9a;

FIG. 9c is another variation on the system of FIG. 9b;

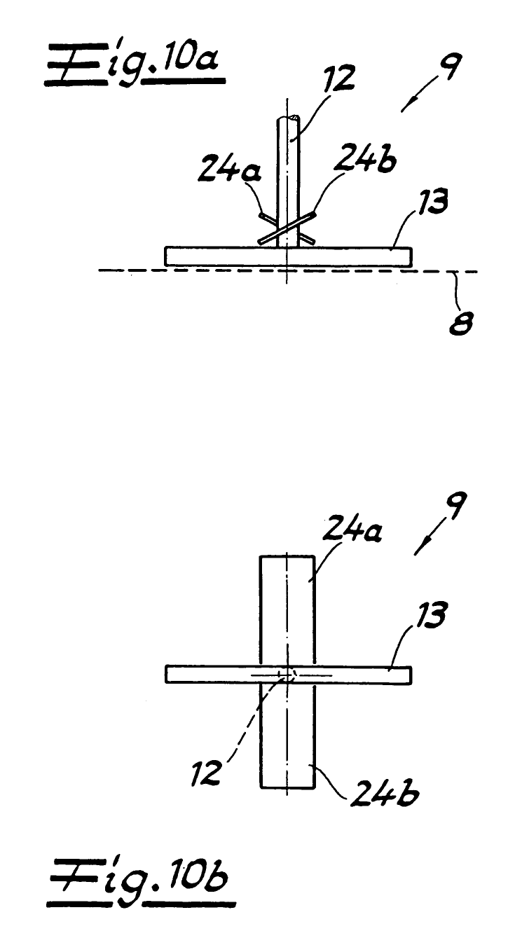

FIG. 10a is a further embodiment of the system of FIG. 6;

FIG. 10b is a bottom view of the system of FIG. 10a.

The figures show an apparatus for spreading particles, in particular glue-coated wood chips, fibers or the like on a conveyor belt 1 to form a particle mat M for the production of chipboard, fiberboard or similar wood structural panels. The particle conveyor 1 is foraminous. The spreading apparatus has a schematically illustrated particle supply with a feeding unit 3. The feeding unit 3 is comprised mainly of a feed belt 4 and several feeding and/or separating rollers 5. Thus particles are supplied by a supply or spreading belt 6 to the hopper or the feeding and/or spreading rollers 5 that break up particle clumps. The hopper is shown filled in FIGS. 1 and 4 above the feed belt 4. The output of the feeding hopper or the feeding unit can be adjusted by decreasing or increasing the advance speed of the feed belt 4. The particles are fed from the feeding unit 3 into the spreading head 7 positioned at the outlet end of the feeding unit and above the particle conveyor 1. This is shown in FIG. 1 in particular. Downstream of the distributing head 7 there is a continuously operating press or a batch press that presses the particle mats into structural wood panels. This press is not shown.

The distributing head 7 is a sifter head 7 with a foraminous floor 8 and a plurality of stirring elements 9 set at predetermined spacings above the foraminous floor 8 and each covering a stirring diameter B. The stirring elements 9 are provided in a housing 10 whose lower wall is formed by the foraminous floor 8 or on whose lower wall the foraminous floor 8 is provided.

According to FIG. 2 the distributing head 7 has spaced apart in the travel direction F a plurality of rows 11 each holding a plurality of the stirring elements 9 spaced apart perpendicular to the travel direction F. The travel direction F is the conveying direction of the particle conveyor 1, that is the belt-travel direction which corresponds generally to the travel direction of the feed belt 4. The individual stirring elements 9 each have at least one blade 13 projecting radially the width B from an axle 12 perpendicular to the foraminous floor. The stirring blades 13 are each for example of one piece and formed as a bar of rectangular or square section. These stirring blades 13 rotate in a common plane that is generally parallel to the foraminous floor 8 and immediately above the foraminous floor 8. Here the stirring blades 13 are double with a stirring diameter B. Arrows in FIG. 2 show how in each row 11 all the stirring elements 9 turn in the same direction. The stirring elements 9 of alternate rows 11 rotate oppositely. This is also shown in FIG. 2. Thus the stirring elements of the first, third, fifth, and seventh rows rotate clockwise while the stirring elements of the second, fourth, sixth, and eighth row rotate counterclockwise. A spacing A between two adjacent stirring elements 9 of each row 11 corresponds generally to the stirring diameter B of the stirring elements so that this spacing A is generally equal to the distance between the axles 12. In addition FIG. 2 shows that adjacent rows 11, for example the first and second row, have a predetermined offset V perpendicular to the travel direction F or belt-travel direction. This offset V of the rows corresponds to half of the stirring diameter so that the first and third rows are once again aligned without offset. Similarly, the spacing C between adjacent rows is slightly less than the stirring diameter B. This is also shown in FIG. 2.

FIG. 3 shows a variation of a stirring element 9 according to the invention having an additional fan vane 14 spaced above the stirring blade 13. This fan vane 14 is angled relative to the respective stirring blade 13 and serves to create a stream of air or blowing effect directed toward the foraminous floor 8.

In the embodiment of FIG. 5 the stirring element also has a fan blade 14 that is oriented generally parallel to the stirring blade 13. In addition the stirring element 9 is surrounded at least near the fan blade 14 by a tubular wall 22. The double-headed arrow in FIG. 5 shows how the fan blade 14 and/or the tube 22 are vertically adjustable. This means that for example a spacing x of the fan blade 14 from the stirring blade 13 can be set or adjusted. To this end the fan blade 14 is movable or slidable on the axle 12 of the stirring element 9 and can be fixed thereon. In this manner the desired stream of air which is produced by the fan blade 14 can be appropriately influenced and controlled.

In the embodiment of FIG. 1, underneath the particle conveyor 1, that is on the side of the foraminous floor 8 opposite the foraminous floor 8, there is a suction box 15 that produces a flow of air from the foraminous floor 8 down to the particle conveyor 1 so that particles are pulled down onto the particle conveyor, that is onto the foraminous belt 1.

FIG. 4 shows an alternative embodiment with several suction boxes 15′ underneath the particle conveyor 1. Here there are a plurality of suction boxes 15′ arranged one after the other in the transport direction and each extending generally perpendicular to the belt-travel direction. They are for example of generally triangular or trapezoidal section. It is furthermore possible that several suction boxes can be lined up perpendicular to the belt-travel direction. This is not shown in the drawing. In any case the suction boxes 15 are connected to one or more suction lines so that the subatmospheric pressure in the individual vacuum lines or the individual suction boxes 15′ can for example be set by throttle valves 21. This makes it possible to control the suction effect of the suction boxes 15′ either of the entire suction system or over its length and/or width so as to accommodate to requirements. When there are several suction boxes 15′ distributed crosswise it is advantageous to connect them to respective suction lines with respective valves for individual control.

In the embodiments the distributing head 7 is provided at its downstream end with an outfeed device 16 extending crosswise to the feed direction F of the travel direction of the particle conveyor 1 for carrying extra chips or coarse particles and excess material away. This outfeed device is shown simply as a feed auger 16. FIG. 2 shows that the overall width S of the distributing head 7 is slightly greater than a width P of the panels being made.

Furthermore between adjacent stirring elements 9 of each row 11 as well as along the outer edges of the distributing head there are partitions or side walls 17 that extend from row to row generally along the entire length of the distributing head 7 and that form feed passages 18 extending generally in the transport direction F. The partition walls 17 are shaped and positioned to fit around the stirring elements so that they form as seen in top view sinusoidal or corrugated passages 18. As a result the particles are moved back and forth in the individual feed passages 18 so as to produce a particularly homogenous particle distribution, both parallel and transverse to the transport direction F. FIG. 2 also shows in part how filler segments 20 can be provided to fill corners 19 between stirring zones.

In the illustrated embodiment the stirring elements 9 are driven with generally the same rotation rate or angular speed. The rotation rate is preferably between 300 RPM and 900 RPM. The system is set up such that, seen in top view, two adjacent stirring elements are in different angular positions, that is one stirring element is ahead of or behind the adjacent stirring elements. Thus even if the stirring elements 9 are packed rather closely together there will be no problems caused by the interfitting stirring elements 9. It is also simply possible when the angular positions of the stirring elements 9 are so coordinated with a constant rotation speed to set the spacing between the stirring element 9 smaller than the stirring diameter B, when of course there are no partitions between the stirring elements. 9. This is however not shown in the drawing.

It is also possible to set the spacings between the stirring elements 9 or the stirring blades 13 and the foraminous floor 8 individually, row-wise, or column wise, as groups and/or all together. In this manner the output of the distributing head can be perfectly matched.

FIGS. 1 and 4 further show the mat M formed on the particle conveyor, with its thickness increasing continuously in the belt-travel direction. The distributing head 7 works preferably such that its entire length is effective for mat formation, that is the desired mat thickness is only reached at the downstream end of the distributing head 7.

Finally FIGS. 6 through 10b show various further embodiments of stirring elements 9. FIG. 6 shows an embodiment of a stirring element 9 where the stirring blade 13 is formed on its lower face with transverse grooves 23. The lower face here is the face turned toward the foraminous floor 8. The grooves 23 are of generally triangular section. In fact other cross-sectional shapes are possible. In any case the turbulence in the particles or the fibers created by the grooves reaches the mesh surface so that the particles are distributed in a particularly uniform manner on the particle conveyor without the formation of clumps. This is in particular true when as shown in FIG. 6 the grooves 23 are staggered, by which is meant that the grooves 23 to one side of the axle 12 are at a different spacing from the grooves 23 on the other side. The grooves 23 could also be distributed asymmetrically.

Another preferred embodiment of the stirring elements 9 is characterized in that the stirring blades 13 and/or the axles 12 carry one or more agitating elements for the particles, e.g. shaped as stirring plates. FIGS. 7a and 7b show by way of example an embodiment wherein the lower face of the stirring blade 13 carries a plurality of spaced apart stirring plates 24. These stirring plates 24 are formed as square or rectangular plates that are perpendicular to the lower face of the stirring blade 13 and parallel to one another. Furthermore the stirring plates 24 are set at a predetermined angle of e.g. 30° to 60° to the longitudinal axis of the stirring blade 13. This makes it possible to mount the stirring plates 24 either fixedly or rotatably on the lower faces of the stirring blades. It is also however possible to make the stirring plates 24 adjustable or pivotal on the stirring blades 13. This is shown in FIG. 7b in dot-dash lines. Thus for example the stirring plates on one side of the stirring blade can be set at a different angle from those on the other side of the axle. In any case the stirring plates 24 produce a uniform distribution of the fibers in the respective stirring fields.

FIG. 8 shows another embodiment wherein stirring plates 24a and 24b are provided. They are on both sides of the stirring blade 13 and each generally perpendicular to the stirring blade 13, the stirring plates 24a and 24b being angled to the horizontal or to the adjacent foraminous floor 8. To this end the stirring plates 24a and 24b are secured to the axle 12 at generally the same level as the stirring blade 13. The angle of the stirring plates 24a and 24b relative to the foraminous floor 8 can be identical or different to both sides of the stirring blade 13. An angle of 30° to 60° to the horizontal is preferable. In any case the result is agitation of the fibers and pushing of the fibers through the foraminous floor.

A further embodiment of the stirring plates is shown in FIGS. 10a and 10b. Here each side of the axle 12 carries a respective stirring plate 24a or 4b at a predetermined spacing above the stirring blade 13. The stirring plates 24a and 24b thus as shown in FIG. 10b extend generally orthogonally to the stirring blade 13 and to the axle 12. FIG. 10a shows that the stirring plates 24a and 24b are angled as in the embodiment of FIG. 8 to the horizontal and to the foraminous floor 8. The stirring plate 24a is set at an angle opposite that of the stirring plate 24b that is mounted on the opposite side of the axle 12. The overall length of the two stirring plates 24a and 24b corresponds generally to the overall length of the stirring blade 13. In addition it is possible that the stirring plates 24a and 24b be made angularly adjustable on the axle 12. This is not shown in the drawing. The angle of the stirring plates to the horizontal or to the foraminous floor 8 is e.g. 30° to 60°.

In the above-described embodiments (see in particular FIGS. 5 to 8 and 10) the stirring blades 13 is always formed as a one-part double blade 13. In contrast FIGS. 9a to 9c show embodiments wherein the stirring blade is formed of two individual arms 13a and 13b which form the double blade 13. The individual arms 13a and 3b are secured eccentrically, that is at a spacing to the rotation axis of the stirring element to the axle 12 of the stirring element 9. FIG. 9a shows an embodiment wherein the individual blades are formed as straight bars extending parallel to each other. The two arms 13a and 13b are however arced oppositely to each other in FIG. 9b, each being shaped as an arcuate or curved blade. The radius of curvature of the two individual arms 13a and 13b is identical. The two arms 13a and 13b each have as shown in FIG. 9b an opposite curvature while the individual arms 13a and 13b in the embodiment of FIG. 9c have as shown in top or bottom view the same direction of arc. These different embodiments of the arms 13a and 13b produce different movements in the particles. This is shown by arrows in FIGS. 9b and 9c. Finally it is possible to make the two individual arms 13a and 13b of different lengths b and b′. FIG. 9a shows an embodiment where the length b′ of the arm 13b is smaller than the length b of the other arm 13a. The length b of the arm 13a is thus equal to about B/2, that is half of the stirring diameter of the double-arm length B. In contrast the length b′ of the arm 13b is about half as great as the length b of the arm 13a so that the length b′ of the arm 13b is equal to about B/4. An embodiment where the lengths b and b′ of the arms 13a and 13b is identical is also shown in FIG. 9a in dot-dash lines.

1-22. (canceled)

23. An apparatus for distributing particles, the apparatus comprising:
a particle conveyor moving continuously in a horizontal travel direction;
a foraminous floor extending horizontally above the conveyor in and transverse to the direction;
means for feeding the particles onto an upstream end of the floor;
an array of rotatable stirring elements immediately above the foraminous floor; and
drive means for rotating the stirring elements and thereby displacing the particles in and transverse to the direction such that the particles pass through the floor and drop down onto the conveyor, the rotating elements each defining a stirring zone having a predetermined zone diameter.

24. The particle-distributing apparatus defined in claim 23 wherein the stirring elements are arrayed in a plurality of rows extending transversely of the direction and spaced apart in the direction.

25. The particle-distributing apparatus defined in claim 24 wherein each stirring element includes
an upright axle defining a respective stirring axis, and
a stirring blade fixed to the axle, projecting radially therefrom, and spaced vertically immediately above the foraminous floor, whereby.

26. The particle-distributing apparatus defined in claim 25 wherein each blade has a diametral length defining the respective zone diameter.

27. The particle-distributing apparatus defined in claim 25 wherein the drive means rotates all the stirring elements in each row in the same direction.

28. The particle-distributing apparatus defined in claim 27 wherein the drive means rotates the stirring elements of adjacent rows in opposite directions.

29. The particle-distributing apparatus defined in claim 25 wherein the axes of the stirring elements in each row are spaced apart transversely of the direction by a distance generally equal to the diameter.

30. The particle-distributing apparatus defined in claim 29 wherein the axes of the stirring elements of each row are offset transverse to the direction from the axes of the stirring elements in adjacent rows by a predetermined offset distance.

31. The particle-distributing apparatus defined in claim 30 wherein the offset distance is equal generally to half of the diameter.

32. The particle-distributing apparatus defined in claim 30 wherein the axes of the stirring element of each row are spaced in the direction from the axes of the stirring elements of adjacent rows by a distance smaller than the diameter.

33. The particle-distributing apparatus defined in claim 25 wherein each stirring element further has
a fan blade carried on the respective axle above the respective stirring blade and oriented to form a downwardly directed current of air on rotation of the respective stirring element.

34. The particle-distributing apparatus defined in claim 33 wherein each fan blade is displaceable along and fixable on the respective axle.

35. The particle-distributing apparatus defined in claim 33 wherein each fan blade has a pair of arms angled to a plane of the foraminous floor.

36. The particle-distributing apparatus defined in claim 23, further comprising
a suction box underneath the conveyor; and
means for applying subatmospheric pressure to the conveyor and thereby pulling particles from the floor down onto the conveyor.

37. The particle-distributing apparatus defined in claim 23, further comprising
upright partitions extending generally in the direction between the stirring elements and defining passages extending in the direction.

38. The particle-distributing apparatus defined in claim 23 wherein the stirring elements in each row offset transversely of the direction from the stirring elements of adjacent rows, the partitions being generally sinusoidal seen from above.

39. The particle-distributing apparatus defined in claim 38, further comprising
filler blocks at corners between adjacent stirring elements.

40. The particle-distributing apparatus defined in claim 23 wherein each stirring element has a lower face formed with a plurality of downwardly open grooves.

41. The particle-distributing apparatus defined in claim 23 wherein each stirring element has a lower face provided with a plurality of downwardly projecting stirring plates.
